(19) United States
(12) Patent Application Publication
(10) Pub. No.: US 2025/0005249 A1
(43) Pub. Date: Jan. 2, 2025

(54) SMART PREDICTOR CIRCUITRY INSERTION BASED ON STRUCTURAL ANALYSIS AND SWITCHING ACTIVITY

(71) Applicant: Xilinx, Inc., San Jose, CA (US)

(72) Inventors: Fan Zhang, San Jose (CA); Chaithanya Dudha, San Jose, CA (US); Nithin Kumar Guggilla, Hyderabad (IN)

(73) Assignee: Xilinx, Inc., San Jose, CA (US)

(21) Appl. No.: 18/344,766

(22) Filed: Jun. 29, 2023

(51) Int. Cl. G06F 30/392

(52) U.S. Cl. CPC G06F 30/392

(57) ABSTRACT

Reducing power consumption of a circuit design includes, for a circuit block of a circuit design, where the circuit block has a plurality of signals, selecting one or more signals of the plurality of signals. Prediction and gating circuitry are generated. The prediction and gating circuitry include a predictor circuit configured to generate a prediction of an output of the circuit block based on the one or more signals as selected and gate the circuit block based on the prediction of the output of the circuit block. The prediction and gating circuitry include an output circuit configured to substitute a constant value as the output of the circuit block responsive to gating the circuit block by the predictor circuit. The prediction and gating circuitry are inserted within the circuit design.

### TECHNICAL FIELD

This disclosure relates to the generation and implementation of circuitry that is capable of reducing power consumption of a circuit design as physically realized in target hardware.

### BACKGROUND

Power consumption is a significant concern when creating circuit designs for implementation in integrated circuits (ICs). Modern computer-based Electronic Design Automation (EDA) tools include a variety of analysis and/or circuit design optimization functions that are capable of modifying a circuit design to create a functionally equivalent version of the circuit design that is more power efficient than the original as physically realized in target hardware such as an IC.

In the usual case, a circuit design is expressed using a hardware description language or a combination of such languages (e.g., System Verilog, Verilog, and/or VHDL). A constraint file for the circuit design is also created that specifies frequency requirements for the circuit design. Using these two inputs, the EDA tool processes the circuit design to physically realize the circuit design in the target hardware. This process, often referred to as a “design flow,” takes into consideration the available hardware primitives of the target hardware such as Application Specific IC (ASIC) circuit blocks, flip-flops, block random access memories, digital signal processors, etc. This is particularly true for programmable ICs such as Field Programmable Gate Arrays.

Some EDA tools are capable of implementing power efficient circuit structures by analyzing the topology of the circuit design. These techniques, however, tend to be restrictive and pattern-based in practice. For example, some EDA tools attempt to reduce power consumption by pre-computing logic to gate inputs to particular circuit blocks to avoid unnecessary switching. While this technique reduces power consumption in theory, in practice the technique is applied by the EDA tools in a brute-force manner that does not reduce power consumption in all cases. Moreover, in some cases, conventional power reduction techniques as described may hinder efforts to reduce power consumption of the circuit design as physically realized in the target hardware.

### SUMMARY

In one or more example implementations, a method includes, for a circuit block of a circuit design, wherein the circuit block has a plurality of signals, selecting one or more signals of the plurality of signals. The method includes generating, by computer hardware, prediction and gating circuitry including a predictor circuit. The predictor circuit is configured to generate a prediction of an output of the circuit block based on the one or more signals as selected and gate the circuit block based on the prediction of the output of the circuit block. The prediction and gating circuitry include an output circuit configured to substitute a constant value as the output of the circuit block responsive to gating the circuit block by the predictor circuit. The method includes inserting, by the computer hardware, the prediction and gating circuitry within the circuit design.

The foregoing and other implementations can each optionally include one or more of the following features, alone or in combination. Some example implementations include all the following features in combination.

In some aspects, the method includes physically realizing the circuit design, including the prediction and gating circuitry, within a target hardware.

In some aspects, the one or more signals of the plurality of signals are selected based on switching activity of the plurality of signals.

In some aspects, the one or more signals of the plurality of signals are selected based on an analysis of functional information for the circuit block.

In some aspects, the one or more signals of the plurality of signals are selected at random.

In some aspects, the method includes iteratively testing different combinations of the one or more signals of the plurality of signals to determine a combination of the one or more signals that provides an improved probability of successful prediction of the output of the circuit block.

In some aspects, the one or more signals of the plurality of signals are selected by prioritizing control signals of the circuit block.

In some aspects, the one or more signals of the plurality of signals are selected by prioritizing particular bit positions of an input provided to the circuit block.

In some aspects, a number of the one or more signals selected is less than a number of the plurality of signals.

In some aspects, the number of the one or more signals selected is less than or equal to a number of inputs of a selected type of primitive of a target hardware in which the circuit design is physically realized.

In one or more example implementations, a system includes one or more hardware processors configured (e.g., programmed) to initiate and/or execute operations as described within this disclosure.

In one or more example implementations, a computer program product includes one or more computer readable storage mediums having program instructions embodied therewith. The program instructions are executable by computer hardware, e.g., a hardware processor, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates certain operative features of an example Electronic Design Automation (EDA) system.

FIG. 2 illustrates an example method of operation of the EDA system of FIG. 1.

FIG. 3 illustrates another example method of operation of the EDA system of FIG. 1.

FIG. 4A illustrates an example of a comparator circuit block.

FIG. 4B illustrates an example of the comparator circuit block of FIG. 4A with probability and gating circuitry.

FIG. 5A illustrates an example of a memory access circuit block.

FIG. 5B illustrates an example of the memory access circuit block of FIG. 5A with probability and gating circuitry.

FIG. 6A illustrates an example of a reduction circuit block.

FIG. 6B illustrates an example of the reduction circuit block of FIG. 6A with probability and gating circuitry.

FIG. 7A illustrates an example of a greater-than circuit block.

FIG. 7B illustrates an example of the greater-than circuit block of FIG. 7A with probability and gating circuitry.

FIG. 8 illustrates an example implementation of the EDA system of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to the generation and implementation of circuitry that is capable of reducing power consumption of a circuit design as physically realized in target hardware such as an integrated circuit (IC). In accordance with the inventive arrangements described within this disclosure, a computer-based Electronic Design Automation (EDA) system is capable of generating circuitry and inserting the generated circuitry into a circuit design. The generated circuitry is operative to reduce power consumption of the circuit design as physically realized in the target hardware.

The generated circuitry is capable of predicting an output of a circuit block of the circuit design. The prediction may be based on one or more of the signals of the circuit block. Based on the predicted output, the generated circuitry is capable of gating (e.g., stopping operation of) the circuit block. That is, for certain situations in which the generated circuitry is able to predict the output of the circuit block, the generated circuitry is capable of pausing operation of the circuit block and outputting a constant value as a result in place of the circuit block computing and outputting a result. For situations in which the generated circuitry is unable to predict the output of the circuit block, the circuit block is permitted to operate to compute and output a result.

The generated circuitry may be implemented in a compact and efficient manner within the target hardware. In some cases, the generated circuitry is able to predict the output of the circuit block based on fewer than all of the signals of the circuit block. For example, the inventive arrangements may implement a process in which a function, as implemented by a circuit block, is decomposed. Specific bits of an input cone of the circuit block may be identified as contributor bits to the switching activity of the decomposed function. The identified bits are used to implement circuitry capable of generating a prediction of the output of the circuit block. Rather than use a brute-force technique that evaluates or considers all of the signals of the input cone, the specifically identified contributor bits of the input cone are used to make the prediction to reduce power consumption.

By predicting the output of the circuit block and selectively gating the circuit block based on the predictions, the circuit design, as modified to include the generated circuitry, reduces the switching activity of the circuit design as realized in the target hardware. The reduction in switching activity arises through gating of the circuit block as described and reduces the power consumption of the target hardware during operation of the circuit design implemented therein. The reduction in power consumption may be obtained despite the addition of the generated circuitry.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

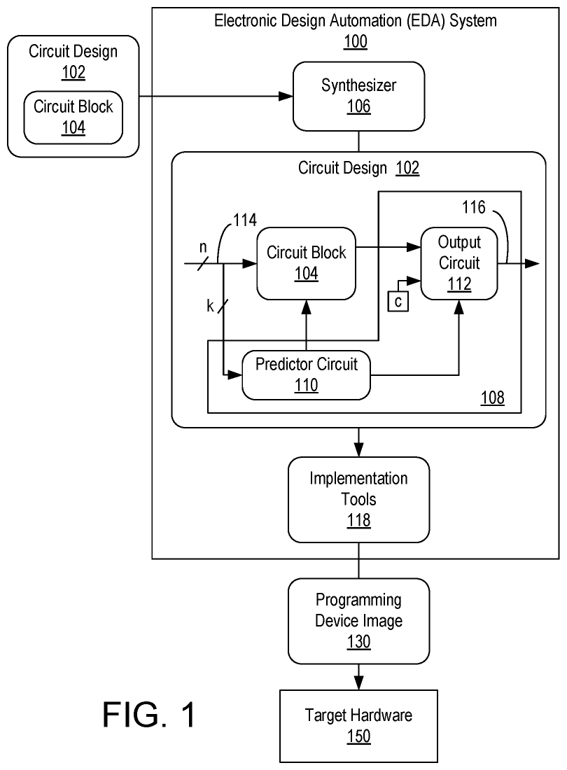

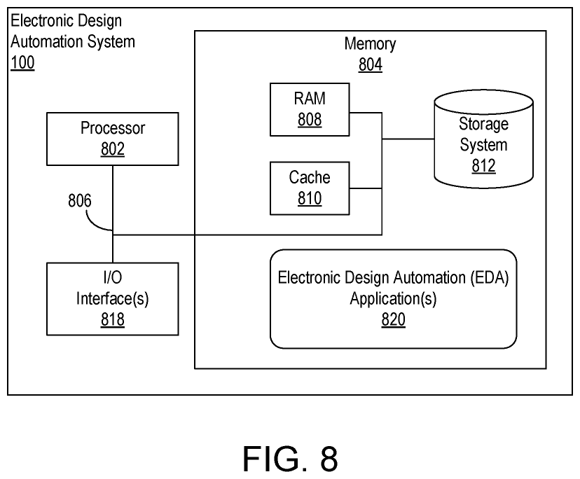

FIG. 1 illustrates certain operative features of an example EDA system 100. EDA system 100 may be implemented as a data processing system, e.g., a computer, executing suitable operational software or program instructions. In the example, EDA system 100 includes a synthesizer 106 that is capable of performing one or more of the operations described within this disclosure. EDA system 100 also includes one or more implementation tools 118. An example of EDA system 100 is described in connection with FIG. 8.

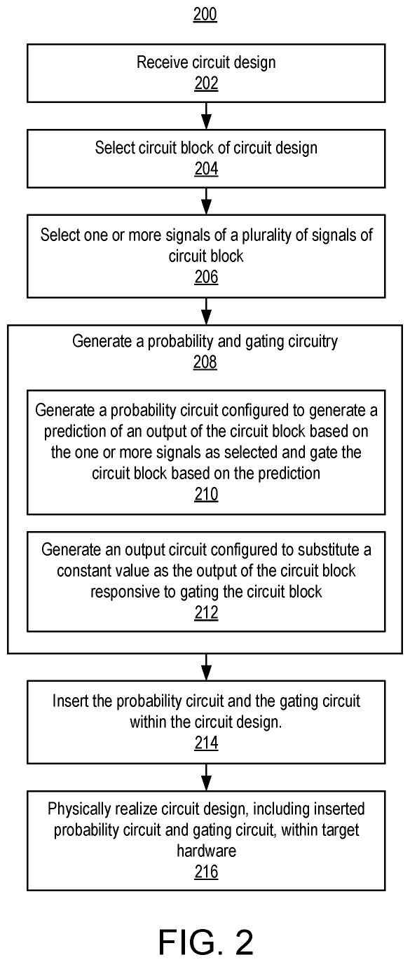

FIG. 2 illustrates an example method 200 of operation of EDA system 100. Referring to FIGS. 1 and 2 in combination, in block 202, EDA system 100 receives a circuit design 102. Circuit design 102 may be specified in hardware description language (e.g., as a register transfer level (RTL) description) and may be formed of one or more modules. The modules may be arranged in a hierarchy. A module is a defined construct within the syntax of the particular hardware description language used to express the RTL description and is part of a hierarchical organization of such modules forming circuit design 102. Circuit design 102 may include one or more circuit blocks. A circuit block may be represented as a module within circuit design 102. In the example, circuit design 102 includes a circuit block 104. Though one circuit block is shown for purposes of illustration, circuit design 102 may include a plurality of circuit blocks that are interconnected. Within this disclosure, the selected circuit block or circuit blocks as the case may be (e.g., circuit block 104) may define a particular function of a number of signals.

In block 204, synthesizer 106 selects circuit block 104 from within circuit design 102. Circuit block 104 includes a plurality of signals. The plurality of signals of circuit block 104 may include a plurality of input signals that provide arguments (e.g., data) to circuit block 104 and/or one or more control signals that are provided to circuit block 104. In one aspect, synthesizer 106 may select circuit block 104 automatically. For example, synthesizer 106 may select particular circuit blocks iteratively for processing to introduce prediction and/or gating circuitry as described hereinbelow. In another aspect, a user input may be received by EDA system 100 that specifies circuit block 104 or a plurality of circuit blocks for processing.

In block 206, synthesizer 106 selects one or more signals of the plurality of signals of circuit block 104. The signals that are selected may be one or more or all of the input signals, one or more or all of the control signals, or any combination of both. The one or more signals of circuit block 104 may be selected by EDA system 100 based on any of a variety of different criteria and/or techniques. For example, the one or more signals of the plurality of signals can be selected based on switching activity of the plurality of signals (e.g., simulation based data specifying static probabilities and/or transition probabilities for signals), based on an analysis of functional information for circuit block 104 (e.g., as may be obtained from a data flow graph representation of circuit block 104 and/or stored metadata for circuit design 102 containing descriptions of circuit blocks), by prioritizing control signals of circuit block 104, by prioritizing particular bit positions of arguments (e.g., most significant bit(s) and/or least significant bit(s)) provided as input data to circuit block 104, selected at random, or various combinations of the foregoing factors.

In block 208, synthesizer 106 generates prediction and gating circuitry 108. Prediction and gating circuitry 108 may include a predictor circuit 110 and an output circuit 112. In block 210, synthesizer 106 generates predictor circuit 110. Predictor circuit 110 is configured to generate a prediction of an output of circuit block 104 based on the one or more signals as selected. Further, predictor circuit 110 is configured to gate circuit block 104 based on the prediction that is generated. In the example, circuit block 104 has signals 114 including “n” different signals, where n is an integer value and may represent a total number of input signals and control signals. The one or more selected signals are represented as “k” signals, where k is an integer value. In one or more example implementations, k may be equal to n.

In one or more other example implementations, k may be less than n. As an illustrative and non-limiting example, in the case where target hardware 150 includes a particular type of primitive, the value of k may be set to the number of inputs of that primitive. Consider an example where target hardware 150 includes programmable logic that includes an “m” input lookup-table as the prevalent circuit structure used to implement user circuit designs, where m is an integer value of 2 or more. In that case, to keep the size of the prediction and gating circuitry reasonably small, k may be set to the value of “m,” e.g., the number of inputs for a single LUT primitive. Thus, if 6-input LUTs are used throughout target hardware 150, k may be set equal to 6. If 8-input LUTs are used throughout target hardware 150, q may be set equal to 8.

In block 212, synthesizer 106 generates output circuit 112. Output circuit 112 is capable of substituting a constant value “c” as the output of circuit block 104 on output signal 116 responsive to predictor circuit 110 gating circuit block 104. For example, output circuit 112 may be implemented as a multiplexer or a switch that is configured to pass an output signal in place of any output from circuit block 104. Output circuit 112 outputs, as signal 116, the value output from circuit block 104 in cases where circuit block 104 is not gated or paused by predictor circuit 110 and outputs the constant value as signal 116 in cases where circuit block 104 is gated.

In the examples described herein, the various techniques described for implementing probability and gating circuitry 108 promote the generation of probability and gating circuitry 108 with a smaller or smallest area and with a higher or highest probability of predicting the output of circuit block 104 to reduce switching power of circuit design 102. This minimizes overhead imposed by probability and gating circuitry 108.

In block 214, synthesizer 106 inserts the probability and gating circuitry 108 within circuit design 102. In inserting probability and gating circuitry 108, synthesizer 106 may connect probability and gating circuitry 108 to circuit block 104 within circuit design 102 and to any other circuit blocks in circuit design 102. In block 216, circuit design 102, including probability and gating circuitry 108, is physically realized within target hardware 150. For example, synthesizer 106 is capable of synthesizing circuit design 102 as modified to generate a technology specific netlist. Implementation tools 118 may include a placer configured to place circuit design 102 as modified and synthesized. Implementation tools 118 may include a router that is capable of routing the placed circuit design. Implementation tools 118 may also generate a programing device image 130 formed of one or more binary files (e.g., configuration data) that may be loaded into target hardware 150 to physically realize circuit design 102, inclusive of probability and gating circuitry 108, within target hardware 150.

In one or more examples, EDA system 100 is capable of performing the operations described in connection with FIG. 2 iteratively. For example, EDA system is capable of iteratively testing different combinations of one or more of signals 114 to determine a combination or sub-combination of such signals that provides an improved probability of successful prediction of the output of circuit block 104.

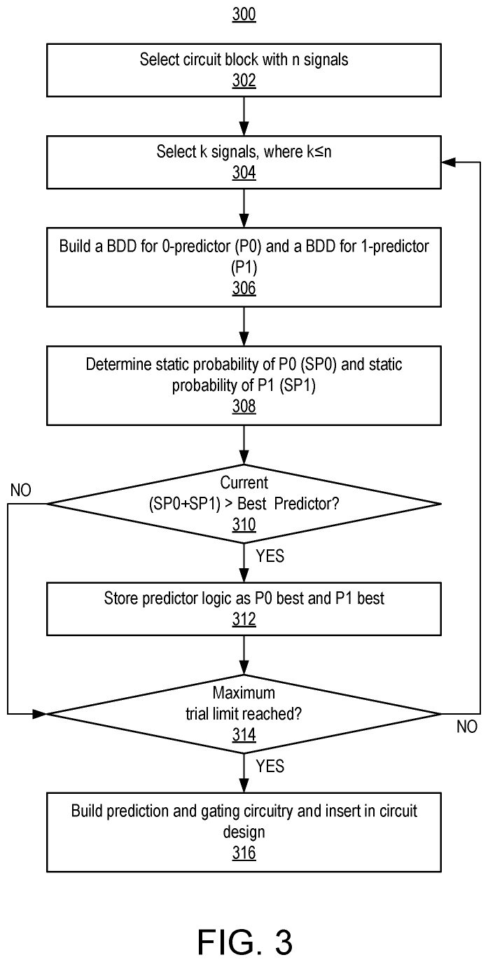

FIG. 3 illustrates another example method 300 of operation of EDA system 100. In the example of FIG. 3, simulation data is presumed to be available that specifies static probabilities and transition probabilities that may be used to choose the k signals provided as input to probability and gating circuitry 108.

In block 302, EDA system 100 selects circuit block 104 (e.g., a function “F”) of circuit design 102. Circuit block 104 may be selected as previously discussed in connection with FIG. 2. In block 304, EDA system 100 selects k signals of the n signals of circuit design 102. In the example of FIG. 3, k is less than or equal to n. For purposes of illustration, k may be set equal to a number of inputs available on a selected primitive of target hardware 150, e.g., a 6-input LUT (e.g., where k=6).

In block 306, EDA system 100 builds binary decision diagrams (BDDs) for the function to be implemented by the k selected signals. A BDD is a data structure that is used to represent a Boolean function as a rooted, directed, acyclic graph that consists of decision nodes and two terminal nodes labeled true and false. In one aspect, BDDs may be generated by EDA system 100 using a technique such as universal quantification for the selected k signals. It should be appreciated, however, that BDDs are known in the art and that any known technique for creating a BDD may be used.

Referring again to block 306, for example, EDA system 100 builds a 0-predictor BDD denoted as P0 for the k signals. The k signals may also be referred to herein as the predictor function “f”). EDA system 100 also builds a 1-predictor BDD denoted as P1 for the function f. Building BDDs is generally known in the art. The P0 predictor provides a “true” output when the function F (e.g., circuit block 104) generates a 0 result. The P1 predictor provides a true output when the function F generates a 1 result.

Because P0 and P1 are created using fewer than all of the available signals of circuit block 104 (e.g., function F), the resulting probability and gating circuitry 108 will be smaller in size than that of circuit block 104. Accordingly, operating probability and gating circuitry 108 and gating circuit block 104, so long as the probability of the prediction generated by probability and gating circuitry 108 being correct is sufficiently high, will result in a reduction of the power consumption of circuit design 102. The probability of the probability and gating circuitry 108 being correct indicates a likelihood of predictor circuit 110 engaging to prevent operation (e.g., gate) operation of circuit block 104.

In block 308, EDA system 100 calculates the static probability of P0, referred to herein as SP0, and calculates the static probability of P1, referred to herein as SP1. The static probabilities may be extracted directly from simulation data available for circuit block 104 and/or circuit design 102 (e.g., vector-based simulation). For example, the simulation data may include one or more of the following types of data or files: an SAIF file containing toggle counts and time information for signals (e.g., how much time a signal was in 1 state(T1), 0 state(T0), x state (TX)), a backward SAIF file providing timing information and/or arc information, and/or a VCD file containing value changes of a signal (e.g., at what times signals change their values).

In one or more other examples, EDA system 100 is capable of propagating probabilities through transitive fan-in cones for circuit block 104. In general, using static probabilities on a sequential boundary from the simulation data will provide greater accuracy in optimizing the selection of the k signals compared to using static probabilities obtained from vector-less propagation. A user, for example, may provide a static probability as a constraint on function F inputs. A vector-less propagation method can be used to compute static probabilities on the outputs of function F, which may be the inputs to other functions (circuit blocks) downstream in circuit design 102. Depending on the fidelity of static probability that is determined, different degrees of power savings may be obtained.

In vector-less propagation, EDA system 100 predicts switching activity of design nodes where no activity is specified by design constraints, or no activity is provided from simulation results. EDA system 100, for example, is capable of assigning initial seeds (default signal rates and static probability) to all undefined nodes. Starting from the design primary inputs, EDA system 100 is capable of propagating activity to the output of internal nodes and repeats this operation until the primary outputs are reached. In performing vector-less propagation, EDA system 100 is capable of understanding the design connectivity, resource functionality, and configuration of the user design.

In block 310, EDA system 100 determines whether the sum of the current SP0 and SP1 is greater than a “best predictor” determined so far. The “best predictor” is a sum of a prior stored SP0 and SP1 pair for a prior iteration of method 300. In response to determining that the current sum exceeds the best predictor, method 300 continues to block 312. In response to determining that the current sum does not exceed the best predictor, method 300 continues to block 314.

In block 312, EDA system 100 stores the predictor logic (e.g., the BDDs for the current set of k signals) as P0 best and P1 best. Continuing with block 314, EDA system 100 determines whether a maximum trial limit is reached. EDA system 100 may count the number of iterations performed and, in response to the number of iterations being equal to a predetermined limit, may exit or continue to block 316. Otherwise, in response to determining that the number of iterations performed is less than the predetermined limit, method 300 loops back to block 304 to select a different set of k signals and begin a new iteration.

In block 316, EDA system 100 generates or builds probability and gating circuitry 108 and inserts the generated circuitry in circuit design circuit design 102. For example, EDA system 100 is capable of building predictor circuit 110 of probability and gating circuitry 108 as !((P0 best)|(P1 best)) which gates n-k inputs with gating logic. That is, predictor circuit 110 implements the logical OR of P0 best and P1 best, as negated. That result may be provided to the enable gate of the original (e.g., primary) input FF of circuit block 104 to gate operation of circuit block 104.

Subsequent to block 316, EDA system 100 may perform additional operations necessary to physically realize circuit design 102, inclusive of probability and gating circuitry 108, within target hardware 150. In the example, the gating logic implemented by predictor circuit 110 may be a version of the prediction logic as represented by the BDDs of P0 best and P1 best. The gating logic implemented by predictor circuit 110, for example, may be implemented as the inverted version of P0 best OR'd with P1 best. Conceptually, in cases where probability and gating circuitry 108 is unable to predict the result of circuit block 104, circuit block 104 should not be gated and should be allowed to compute and output a result. In cases where probability and gating circuitry 108 is able to predict the result of circuit block 104, circuit block 104 should be gated and a constant output in place of circuit block 104 computing and outputting a result.

The iterative nature of method 300 allows EDA system 100 to continue to determine a set of k signals that maximizes the probability (P0+P1) that probability and gating circuitry 108 will accurately predict the output of circuit block 104, which increases the probability of being able to gate, or shut down, circuit block 104.

In cases where simulation data is not available, method 300 may be adapted to use an alternative technique for selecting the k signals. As discussed in connection with FIG. 2, techniques such as those based on an analysis of functional information for circuit block 104, e.g., where the function or type of circuit block is known or determined, signals may be selected by prioritizing certain signals. The signals that may be prioritized can include control signals of circuit block 104 or particular bit positions of arguments (e.g., most significant bit(s) (MSBs) and/or least significant bit(s) (LSBs)) provided as input data to circuit block 104. In other cases, signals may be randomly selected. In the case where simulation data is unavailable, method 300 may be adapted for use by omitting blocks such as 306, 308, 310, 312, and 314 where probability and gating circuitry 108 is generated automatically based on the k signals selected automatically by EDA system 100 using one of the aforementioned non-simulation-related signal selection techniques.

In one or more examples where functional information of circuit design 102 is used, EDA system 100 may favor certain signals of circuit block 104 considered dominant. As an illustrative and non-limiting example, in cases where EDA system 100 is capable of identifying the function being performed by circuit block 104 and/or the type of circuit block 104, whether by analysis of metadata and/or of a directed flow graph of circuit design 102, EDA system 100 may include particular rules for selecting signals as part of the k signals to be used by probability and gating circuitry 108 in generating a prediction of the output of circuit block 104. Examples of signals considered dominant may include, but are not limited to, control signals for multiplexers, state registers of finite state machines and control inputs thereof. For some functions implementing data path operators, one or more LSBs or one or more MSBs may be considered dominant. For example, in the case where a circuit block compares two wide bus signals, the MSBs of each bus may be more dominant and used as the k signals.

In one or more other examples, in cases where functional data and simulation data are available, such data may be used in combination. For example, of a favored set of signals (e.g., the MSBs) for a comparison function, EDA system 100 may select those signals with lower switching activity (as determined from simulation data) from among the favored set of signals for each bus. Selection of signals with lower switching activity for use by probability and gating circuitry 108 leads to increased probability of a successful prediction of the output of circuit block 104.

In one or more other examples, EDA system 100 may identify signals with low switching, e.g., switching below a predefined threshold, based on heuristics (e.g., predefined rules) and/or simulation data. EDA system 100 also may consider user provided information in identifying low switching signals in combination with heuristics and/or simulation data to select the set of signals, e.g., input signals and/or control signals, that will be used to gate circuit block 104 (e.g., the N-input function).

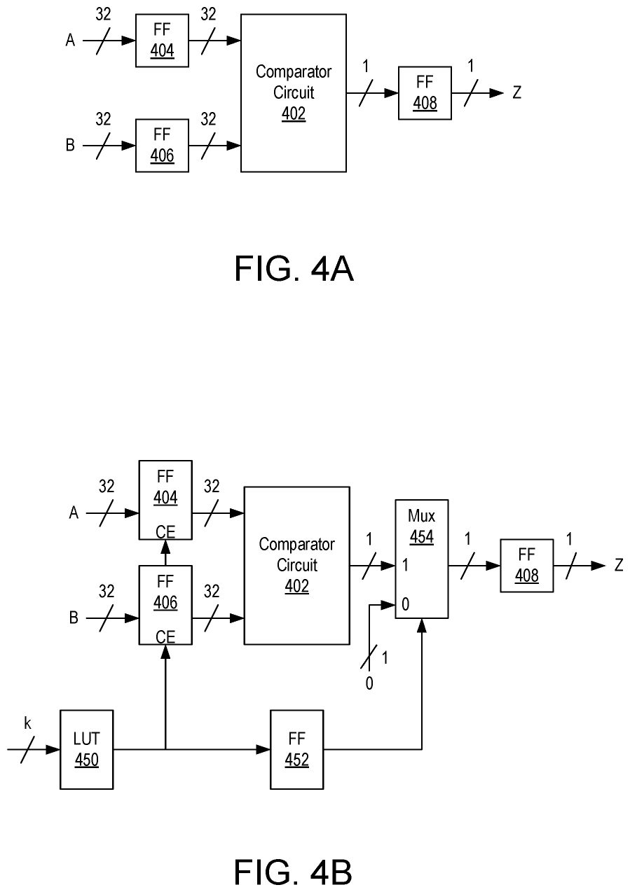

FIGS. 4, 5, 6, and 7 illustrate different circuit blocks (functions) and examples of probability and gating circuitry 108 that may be implemented for each. The examples of FIGS. 4, 5, 6, and 7 are also illustrative of different approaches that may be used to select the k signals provided to probability and gating circuitry 108 as input for making predictions of the output of circuit block 104. For example, the particular signals selected as the k signals may be defined as a set of rules that correspond to particular identifiable circuit blocks or functions.

FIG. 4A illustrates an example of a comparator circuit block. The comparator circuit structure of FIG. 4A includes a comparator circuit 402 configured to compare two 32-bit inputs A and B. The inputs A and B are received via flip-flops (FFs) 404 and 406. Comparator circuit 402 performs a 32-bit by 32-bit comparison of A and B and generates a 1-bit output Z that is passed through FF 408. The output Z is 1 in the case where A is equal to B and is 0 in the case where A is not equal to B.

FIG. 4B illustrates an example of the comparator circuit block of FIG. 4A with probability and gating circuitry 108. In the example, probability and gating circuitry 108 include LUT 450, FF 452, and multiplexer 454. In the example, LUT 450 implements predictor circuit 110 and multiplexer 454 implements output circuit 112. For purposes of illustration, consider the case in which LUT 450 is a 6-input LUT. The k signals provided to LUT 450 include 3 signals selected from A and the corresponding 3 signals selected from B.

In the example, EDA system 100 chooses 3 indices with high switching activity and then selects the corresponding signals from each of inputs A and B as the k signals provided to LUT 450. If, for example, indices 18 and 19 from input A have high switching activity and index 25 from input B has high switching activity, then EDA system 100 may select signals A[18], A[19], A[25] and B[18], B[19], B[25] as the k signals provided to LUT 450. LUT 450 may implement a function such as {A[18],A[19],A[25]}=={B[18],B[19],B[25]}.

If the 3-bit comparison performed by LUT 450 is true, LUT 450 may output a 1 that is provided to the clock-enable port of FFs 404, 406 thereby enabling both LUTs so that each provides a 32-bit argument (e.g., A and B, respectively) to comparator circuit 402. Similarly, the 1 output from LUT 450 selects input 1 of multiplexer 454 so that the result computed by comparator circuit 402 is output as Z. In the case where LUT 450 outputs a value of 1, because the 3 bits from each of A and B match, it is unknown whether the remaining bits of A and B match. Accordingly, the circuit block is permitted to operate by providing a high value to each clock enable port of FFs 404, 406 and selecting input port 1 of multiplexer 454. In the case where the comparison performed by LUT 450 is true, probability and gating circuitry 108 is unable to predict the result of the compactor circuit block.

If the 3-bit comparison performed by LUT 450 results in 0 (the compared bits were not equal), then LUT 450 gates FFs 404, 406 by providing a low signal to the clock enable ports of each of FFs 404, 406. Further, input port 0 is selected on multiplexer 454, which causes the constant of 0 to be output as Z (indicating that A and B do not match). In the case where the comparison performed by LUT 450 is false, probability and gating circuitry 108 is able to predict the result of the compactor circuit block. In this example, there is no way that A can equal B. By preventing switching activity of FFs 404, 406 and of comparator circuitry 402, power consumption of circuit design 102 may be reduced. The switching activity and power consumed by operation of LUT 450, FF 452, and multiplexer 454 in this scenario is less than that of FFs 404, 406 and comparator circuit 402. The larger the probability of probability and gating circuitry 108 accurately predicting the output of circuit block 104 (e.g., based on the selected k signals), the greater the power savings that may be achieved as the comparator circuit block will be gated more frequently.

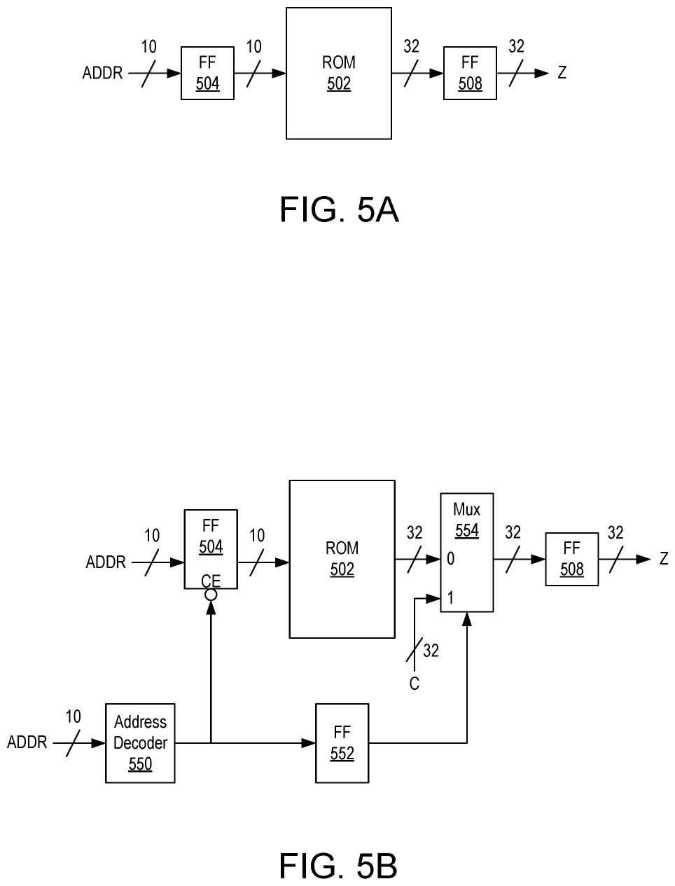

FIG. 5A illustrates an example of a memory access circuit block. The memory access circuit block of FIG. 5A includes a FF 504 configured to receive a 10-bit address and provide the 10-bit address to ROM 502. ROM 502 outputs a value stored at the received address as a 32-bit value to FF 508 and then out as Z.

FIG. 5B illustrates an example of the memory access circuit block of FIG. 5A with probability and gating circuitry 108. In the example, probability and gating circuitry 108 includes address decoder 550, FF 552, and multiplexer 554. In the example, address decoder 550 implements predictor circuit 110 and multiplexer 554 implements output circuit 112. In this example, it may be the case that a particular address is read from ROM 502 a significant number of times. In the example of FIG. 5B, address decoder 550 receives the same 10-bit address signal as FF 504 (e.g., n=k). In this example, address decoder 550 is checking whether the 10-bit address received is a particular and predetermined address of ROM 502. The value stored at that predetermined address may be specified as a constant “c” that is provided to input port 0 of multiplexer 554.

Thus, in cases where the address received does not match the predetermined address as determined by address decoder 550, the output of ROM 502 may not be predicted. Accordingly, address decoder outputs a 0, which enables FF 504 (by virtue of the inverter at the CE port of FF 504) and operation of ROM 502. The 0 value as output from address decoder 550 selects input port 0 of multiplexer 554 which passes the value read from ROM 502 as Z. In the case where the received address does match the predetermined address as determined by address decoder 550, the output of ROM 502 can be predicted. Accordingly, address decoder outputs a 1 which disables FF 504 and ROM 502 and selects input port 1 of multiplexer 554 thereby passing the constant value as Z. The constant value is the value stored at the predetermined address of ROM 502.

FF 504 and ROM 502 are gated in response to detecting the predetermined address that is considered a “high switching activity” address. The switching activity and power consumed by operation of address decoder 550, FF 452, and multiplexer 454 with FF 504 and ROM 502 gated is less than that of FF 504 and ROM 502. The larger the probability of probability and gating circuitry 108 accurately predicting the output of circuit block 104, the greater the power savings that may be achieved. Such is the case in FIG. 5B despite multiplexer 554 being large enough to handle two 32-bit inputs. It should be appreciated, however, that probability and gating circuitry 108 of FIG. 5B does require more area owing to the number of inputs k to address decoder 550 being equal to n and the increased size of multiplexer 554.

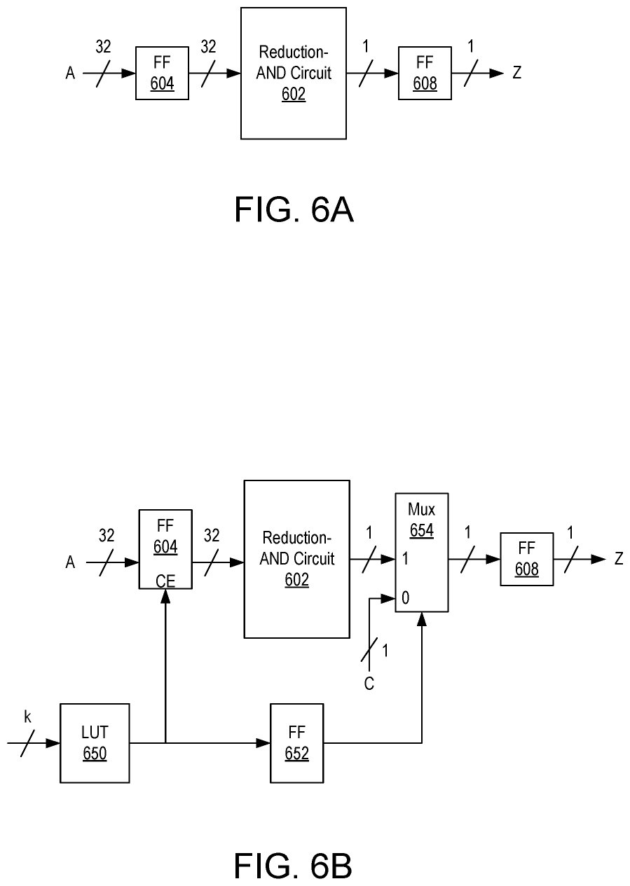

FIG. 6A illustrates an example of a reduction circuit block. The reduction circuit block includes a FF 604 configured to receive a 32-bit input A and provide the 32-bit input to reduction-AND circuit 602. Reduction-AND circuit 602 is capable of reducing the received input to a 1-bit output by performing a logical AND operation on the received 32-bit signal. The 1-bit reduced result is output to FF 608, which outputs the 1-bit value as Z.

FIG. 6B illustrates an example of the reduction circuit block of FIG. 6A with probability and gating circuitry 108. In the example, probability and gating circuitry 108 include a LUT 650, FF 652, and multiplexer 654. In the example, LUT 650 may be implemented as a 6-input LUT. For purposes of illustration, EDA system 100 may select k signals (e.g., where k=6 in this example) that are signals from input A of FF 604. The particular signals from input A may be selected based on switching activity. The switching activity may be extracted from a VCD file or an SAIF file, for example.

In the example of FIG. 6B, any time at least one of the k signals received by LUT 650 is a 0, LUT 650 is able to predict the output of reduction-AND circuit 602. The output of LUT 650, being 0, gates (disables) FF 604 and reduction-AND circuit 602. Further, LUT 650 selects input port 0 of multiplexer 654 thereby passing a constant (e.g., “0”) as Z. Any time the k signals received by LUT 650 are all 1s, LUT 650 is unable to predict the output of reduction-AND circuit 602 and outputs a 1. In the case where LUT 650 outputs a 1, the remaining signals included in A are unknown. Accordingly, LUT 650 allows FF 604 and reduction-AND circuit 602 to operate (e.g., the circuits are not gated). Further, LUT 650 outputs a value that selects input port 1 of multiplexer 654 so that the result from reduction-AND circuit 602 is passed as Z.

In the example of FIG. 6B, the switching activity and power consumed by operation of LUT 650, FF 652, and multiplexer 654 with FF 604 and reduction-AND circuit 602 gated is less than that of FF 604 and reduction-AND circuit 602 when operating (not being gated). The larger the probability of probability and gating circuitry 108 accurately predicting the output of circuit block 104 by virtue of selecting appropriate k signals, the greater the power savings that may be achieved.

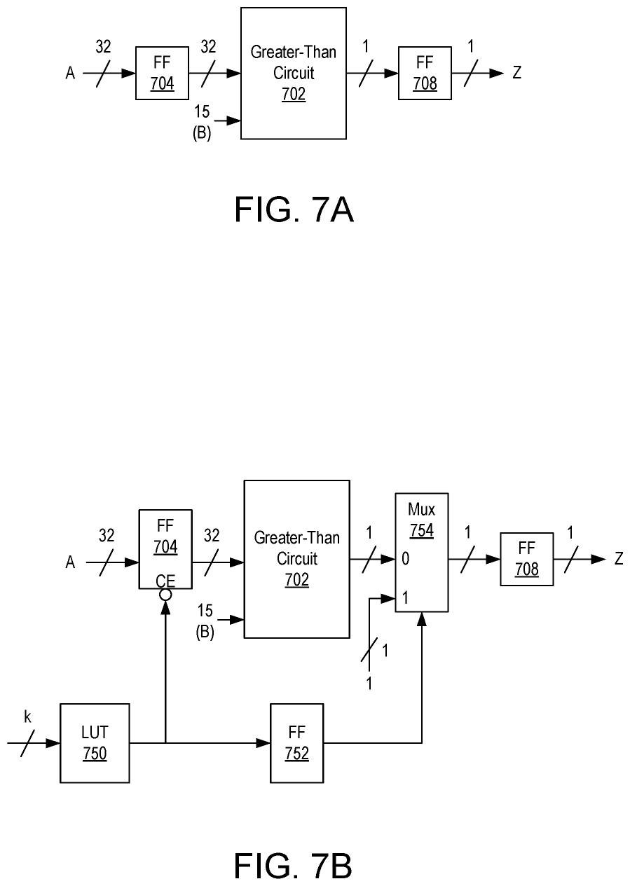

FIG. 7A illustrates an example of a greater-than circuit block. Greater-than circuit 702 implements “A>B,” where both A and B are 32-bit unsigned numbers. The greater-than circuit block includes a FF 704 configured to receive a 32-bit input A and provide the 32-bit argument to a greater-than circuit 702. Greater-than circuit 702 is capable of comparing the received input A against a particular constant c. Greater-than circuit 702 outputs a 1-bit signal propagated through FF 708 as Z that indicates whether input A is greater than c. In the example of FIG. 7, c=15 (decimal).

FIG. 7B illustrates an example of the greater-than circuit block of FIG. 7A with probability and gating circuitry 108. In the example, probability and gating circuitry 108 includes a LUT 750, FF 752, and multiplexer 754. In the example, LUT 750 may be implemented as a 6-input LUT. For purposes of illustration, EDA system 100 may select k signals (e.g., where k=6 in this example) that are signals from the input A of FF 704. In this example, EDA system 100 selects signals by favoring those bits on the MSB side or portion of input A. In implementations of the greater-than block with less switching activity, the overhead of implementing probability and gating circuitry 108 may be too great. The 6-bits from input A selected and provided to LUT 750 may be any 6-bits of the 28 MSBs of input A. In the example, if at least one of the k signals selected from input A as provided to LUT 750 is 1, then LUT 750 outputs a 1, which gates FF 704 by operation of the inverting input to prevent operation of greater-than circuit 702. In addition, input port 1 of multiplexer 754 is selected, which passes a 1 value (e.g., a constant) indicating that A>B. If each of the k signals of input A is 0, then the predictor circuit is unable to predict, based on the k signals, whether A is greater than B. In that case, LUT 750 outputs a 0 value, which allows both FF 704 and greater-than circuit 702 to operate. Further, input port 0 of multiplexer 754 is selected, which passes the comparison result generated by greater-than circuit 702.

FIG. 8 illustrates an example implementation of EDA system 100. EDA system is implemented as a data processing system. As defined herein, the term “data processing system” means one or more hardware systems configured to process data, each hardware system including at least one processor and memory, wherein the processor is programmed with computer-readable instructions that, upon execution, initiate operations. EDA system 100 can include a processor 802, a memory 804, and a bus 806 that couples various system components including memory 804 to processor 802.

Processor 802 may be implemented as a hardware processor having one or more circuits capable of carrying out instructions contained in program code. The circuit(s) may be an integrated circuit or embedded in an integrated circuit. Processor 802 may represent one or more processors. In an example, processor 802 is implemented as a central processing unit (CPU). Processor 802 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 806 represents one or more of any of a variety of communication bus structures. By way of example, and not limitation, bus 806 may be implemented as a Peripheral Component Interconnect Express (PCIe) bus. EDA system 100 typically includes a variety of computer system readable media. Such media may include computer-readable volatile and non-volatile media and computer-readable removable and non-removable media.

Memory 804 can include computer-readable media in the form of volatile memory, such as random-access memory (RAM) 808 and/or cache memory 810. EDA system 100 also can include other removable/non-removable, volatile/non-volatile computer storage media. By way of example, storage system 812 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 806 by one or more data media interfaces. Memory 804 is an example of at least one computer program product.

Memory 804 is capable of storing computer-readable program instructions that are executable by processor 802. For example, the computer-readable program instructions can include an operating system, one or more application programs, other program code, and program data. For example, memory 804 may store an EDA application 820 that is executable by processor 802 to perform the various operations described within this disclosure. EDA application 820, for example, may include synthesizer 106 and implementation tools 118. As discussed, in addition to the operations described herein with respect to generation and insertion of probability and gating circuitry 108 within circuit design 102, EDA system 100 is also capable of performing a design flow (e.g., synthesis, placement, and/or routing) circuit design 102 to physically realize circuit design 102 in target hardware 150.

A particular type and/or model of IC in which a circuit design is to be implemented is an example of target hardware 150. Examples of an IC used as target hardware 150 may include, but are not limited to, a System-on-Chip (SoC), a programmable IC, a Field Programmable Gate Array (FPGA), or other integrated circuit that includes at least some programmable circuitry. Programmable logic is an example of programmable circuitry.

Within this disclosure, data items used, generated, and/or operated upon by a data processing system such as EDA system 100 are functional data structures that impart functionality when employed by the data processing system. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

EDA system 100 may include one or more Input/Output (1/O) interfaces 818 communicatively linked to bus 806. I/O interface(s) 818 allow EDA system 100 to communicate with one or more external devices and/or communicate over one or more networks such as a local area network (LAN), a wide area network (WAN), and/or a public network (e.g., the Internet). In the example, EDA system 100 is capable of loading programming device image 130 into target hardware 150 using I/O interfaces 818. Examples of I/O interfaces 818 may include, but are not limited to, network cards, modems, network adapters, hardware controllers, buses (e.g., Universal Serial Buses, Peripheral Component Interconnect Express or “PCIe” buses, etc.).

The data processing system is only one example implementation of EDA system 100. A data processing system used to implement EDA system 100 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 8 is not intended to suggest any limitation as to the scope of use or functionality of example implementations described herein. EDA system 100 is an example of computer hardware that is capable of performing the various operations described within this disclosure. In this regard, the data processing system may include fewer components than shown or additional components not illustrated in FIG. 8 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the terms “individual” and “user” each refer to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
for a circuit block of a circuit design, wherein the circuit block has a plurality of signals, selecting one or more signals of the plurality of signals;
generating, by computer hardware, prediction and gating circuitry including a predictor circuit configured to generate a prediction of an output of the circuit block based on the one or more signals as selected and gate the circuit block based on the prediction of the output of the circuit block;
wherein the prediction and gating circuitry includes an output circuit configured to substitute a constant value as the output of the circuit block responsive to gating the circuit block by the predictor circuit; and
inserting, by the computer hardware, the prediction and gating circuitry within the circuit design.

2. The method of claim 1, physically realizing the circuit design, including the prediction and gating circuitry, within a target hardware.

3. The method of claim 1, wherein the one or more signals of the plurality of signals are selected based on switching activity of the plurality of signals.

4. The method of claim 1, wherein the one or more signals of the plurality of signals are selected based on an analysis of functional information for the circuit block.

5. The method of claim 1, wherein the one or more signals of the plurality of signals are selected at random.

6. The method of claim 1, further comprising:
iteratively testing different combinations of the one or more signals of the plurality of signals to determine a combination of the one or more signals that provides an improved probability of successful prediction of the output of the circuit block.

7. The method of claim 1, wherein the one or more signals of the plurality of signals are selected by prioritizing control signals of the circuit block.

8. The method of claim 1, wherein the one or more signals of the plurality of signals are selected by prioritizing particular bit positions of an input provided to the circuit block.

9. The method of claim 1, wherein a number of the one or more signals selected is less than a number of the plurality of signals.

10. The method of claim 9, wherein the number of the one or more signals selected is less than or equal to a number of inputs of a selected type of primitive of a target hardware in which the circuit design is physically realized.

11. A system, comprising:
one or more hardware processors configured to initiate operations including:
for a circuit block of a circuit design, wherein the circuit block has a plurality of signals, selecting one or more signals of the plurality of signals;
generating prediction and gating circuitry including a predictor circuit configured to generate a prediction of an output of the circuit block based on the one or more signals as selected and gate the circuit block based on the prediction of the output of the circuit block;
wherein the prediction and gating circuitry includes an output circuit configured to substitute a constant value as the output of the circuit block responsive to gating the circuit block by the predictor circuit; and
inserting the prediction and gating circuitry within the circuit design.

12. The system of claim 11, wherein the one or more signals of the plurality of signals are selected based on switching activity of the plurality of signals.

13. The system of claim 11, wherein the one or more signals of the plurality of signals are selected based on an analysis of functional information for the circuit block.

14. The system of claim 11, wherein the one or more signals of the plurality of signals are selected at random.

15. The system of claim 11, wherein the one or more hardware processors are configured to initiate operations further comprising:
iteratively testing different combinations of the one or more signals of the plurality of signals to determine a combination of the one or more signals that provides an improved probability of successful prediction of the output of the circuit block.

16. The system of claim 11, wherein the one or more signals of the plurality of signals are selected by prioritizing control signals of the circuit block.

17. The system of claim 11, wherein the one or more signals of the plurality of signals are selected by prioritizing particular bit positions of an input provided to the circuit block.

18. The system of claim 11, wherein a number of the one or more signals selected is less than a number of the plurality of signals.

19. The system of claim 18, wherein the number of the one or more signals selected is less than or equal to a number of inputs of a selected type of primitive of a target hardware in which the circuit design is physically realized.

20. A computer program product comprising one or more computer readable storage mediums having program instructions embodied therewith, wherein the program instructions are executable by computer hardware to cause the computer hardware to initiate executable operations comprising:
for a circuit block of a circuit design, wherein the circuit block has a plurality of signals, selecting one or more signals of the plurality of signals;
generating, by computer hardware, prediction and gating circuitry including a predictor circuit configured to generate a prediction of an output of the circuit block based on the one or more signals as selected and gate the circuit block based on the prediction of the output of the circuit block;
wherein the prediction and gating circuitry includes an output circuit configured to substitute a constant value as the output of the circuit block responsive to gating the circuit block by the predictor circuit; and
inserting, by the computer hardware, the prediction and gating circuitry within the circuit design.
